(19) United States
(12) Patent Application Publication
(10) Pub. No.: US 2019/0362022 A1
(43) Pub. Date: Nov. 28, 2019

(54) AUDIO FILE LABELING PROCESS FOR BUILDING DATASETS AT SCALE

(71) Applicants: Risto Haukioja, Palo Alto, CA (US); Leon Mak, San Francisco, CA (US); Mark Ruiz, San Francisco, CA (US); Eli Sakov, San Francisco, CA (US)

(72) Inventors: Risto Haukioja, Palo Alto, CA (US); Leon Mak, San Francisco, CA (US); Mark Ruiz, San Francisco, CA (US); Eli Sakov, San Francisco, CA (US)

(21) Appl. No.: 15/989,205

(22) Filed: May 25, 2018

(51) Int. Cl. G06F 17/30; G10L 15/04; G06F 3/0482

(52) U.S. Cl. CPC G06F 17/30743; G06F 3/0482; G10L 15/04

(57) ABSTRACT

An audio labeling tool is described for rapidly and efficiently building a labeled data set preferably comprising audio files with annotations denoting speaker transcriptions, speaker identity, periods of silence, background noise, and speaker emotion labels. The tool provides a configurable user interface (UI) with keyboard shortcuts and menu items for streamlined user-guided markup of audio files with context specific labeling and transcription notes. Human audio file labelers will preferably leverage the labeling tool and configurable user interface and menu to rapidly annotate, validate, and build labeled data sets, at scale, of time sliced audio files. The audio labeling tool is preferably applied to audio files and provides an automated means for adding notations, markup, text transcription, and feature labeling to an audio waveform, spectrogram, or other audio data visualization domain for amplifying and highlighting audio feature details. Labeled audio data is preferably used to train computer models, develop pattern recognition algorithms, and neural networks for automated processing, pre-populating and labeling of significantly large audio data sets at scale.

### BACKGROUND

The development of audio and speech artificial intelligence (AI) technology may be advanced with three primary audio related technologies: 1) improving automatic speech recognition (ASR) and automatically transcribing audible speech to readable text; 2) improving speech emotion recognition (SER), where the speaker's emotional state is determined by machine; and 3) improving sound and audio classification and labeling, where sounds, speech, and contextually relevant audible features are identified, validated, and labeled at scale across large databases with machine learning and pattern recognition. For all of these technologies, the preliminary task is creating and building a control set of labeled audio data. In the area of ASR and speech to text transcription, the task may preferably comprise labeling audio recordings for periods of silence, noise, background noise, transcriptions of what the speaker is saying, who the speaker is, and other characteristics. For speech emotion recognition (SER), the audio recordings may be tagged and labeled for speaker emotional state, i.e., happy, upset, excited, nervous, tired, etc. In an electronic audio file, unique speaker dependent words, phrases, mannerism, and manners of speaking may be identified, labeled, tagged, annotated, and submitted for processing with a labeling interface. The control group of human labeled audio file segments reflecting a speaker's common utterances may be processed by a system for machine learning, pattern recognition, and feature extraction. The labeled audio file features may be used to identify and label similar speaker dependent utterances and phrases at scale in a large dataset of unlabeled audio files.

Building a set of labeled audio data allows the development and training of computer models, pattern recognition algorithms, and neural networks for automated processing, pre-populating and labeling of additional audio data sets. A benchmark of contemporary ASR methods has found that about thirty to forty thousand hours (30-40K) of labeled data allow the development of highly useful machine learning models. The audio labeling tool system and methods described here envision the creation of thousands of hours of labeled data; and preferably tens of thousands of hours of labeled data for attaining automatic speech to text and automatic emotion recognition accuracy levels of ninety plus percent (+90%).

But before such levels of accuracy can be contemplated, the computer models must be given accurately labeled data sets built by human labelers. Currently available native audio tools allow the markup and labeling of audio files, but are not well-designed for fast and efficient batch labeling jobs done by human labeling teams for amassing large sets of labeled audio data. Performance metrics with native tools would yield only about two to three (2-3) minutes of labeled audio for every one (1) hour of human effort, and about twenty (20) minutes per workday of effort. These metrics are unacceptable for the timely creation of labeled data sets for training computer models and neural networks for development of ASR, SER and sound classification artificial intelligence technologies. In order to scale up audio file labeling capabilities, a custom tool with a configurable user interface (UI), keyboard shortcuts and menu items for streamlined user-guided markup of audio files with context specific labeling and transcription notes is needed. Teams of human labelers may preferably leverage such a tool to rapidly annotate, validate, and build labeled data sets of time sliced audio files.

### SUMMARY

The presently described audio labeling tool is designed to streamline and efficiently optimize the human task of creating of labeled data. In a preferred workflow, the tool may sit and process data between the raw audio file data received by users and the end-product of qualified labeled data for the training of neural networks for ASR, SER and computerized pattern recognition techniques. In another preferred workflow, there may also be an optional pre-processing stage performing preliminary labeling and removing certain parts of audio before presentation to the labelers. This pre-processing stage will preferably mark or remove known areas such as silence, noise or easily detectable words from the audio files. Machine driven pre-processing will preferably minimize the human effort required by the labeler. Pre-processing may be utilized and performed continuously by the system, during labeling tasks, and for preferably leveraging the efforts and work product of human labelers. For example, in a preferred embodiment, a human labeler may perform the labeling of custom sounds or words, in such a way that, for example, the way an individual says the phrase, “How's it going?”, or “How may I help you today?”, may be used as input for machine learning algorithm(s) and a model(s) that can be trained on the fly with this information, thus reducing the number of times the manual labeller may need to textually annotate, “How's it going”, or other phrase, to an unlabeled waveform.

An audio file is preferably displayed on the user interface and visualized as a waveform, or spectrogram, in order to graphically depict audio details and distinguishing features. The human labeler is then tasked with listening to the audio file and then marking up the waveform or spectrogram features with context specific labels. For example, the labeler may select a waveform feature and add a label to describe the speaker's identity (i.e. speaker 1, speaker 2, etc.), label periods of silence, label periods of noise, and label periods of speech and spoken audio with textual descriptions or transcriptions.

The audio labeling tool may be web browser based and may be preferably customized with keyboard shortcuts for playing or pausing the audio file, adding a waveform selection, zooming in, zooming out, canceling label input, jumping forward, jumping backward, and adding context specific labels (i.e., agent name, customer name, topic discussion, emotion label, language descriptors, etc.). The tool may provide audio data visualization with a waveform, spectrogram, or other method for aiding the human labeler with feature identification and resolution. Labels are preferably added to specific time slice periods of localized audio feature regions to characterize the audio with context specific descriptors. The human labeler may preferably listen to the audio file, adjust the play head, zoom in, select a region, and then using keyboard shortcuts and customized menu selections, rapidly and efficiently label specific periods of the audio waveform with textual descriptions of the speaker's content or add literal transcriptions of spoken natural language audio.

### DESCRIPTION OF THE DRAWINGS

FIG. 1 is a view of the audio labeler tool with a waveform showing the time slice audio file features with localized regions annotated with context specific labels for periods of spoken voice, silence, background noise, speaker identity, and literal text transcription.

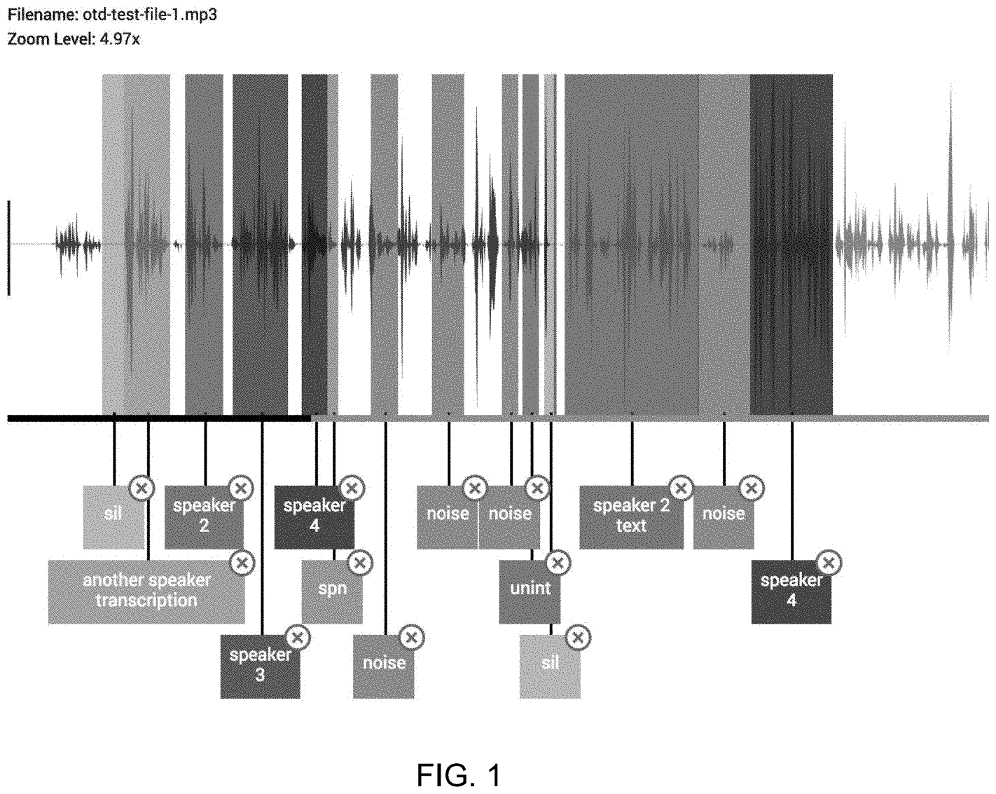

FIG. 2 is a view of the web-browser based audio labeler tool showing the time slice audio waveform and context specific labels, markup and annotations; the audio labeler tool Keyboard/Mouse Controls are shown at the bottom left; and the configurable menu buttons are at the bottom right for zooming, playing, skipping and submitting the labeled audio file.

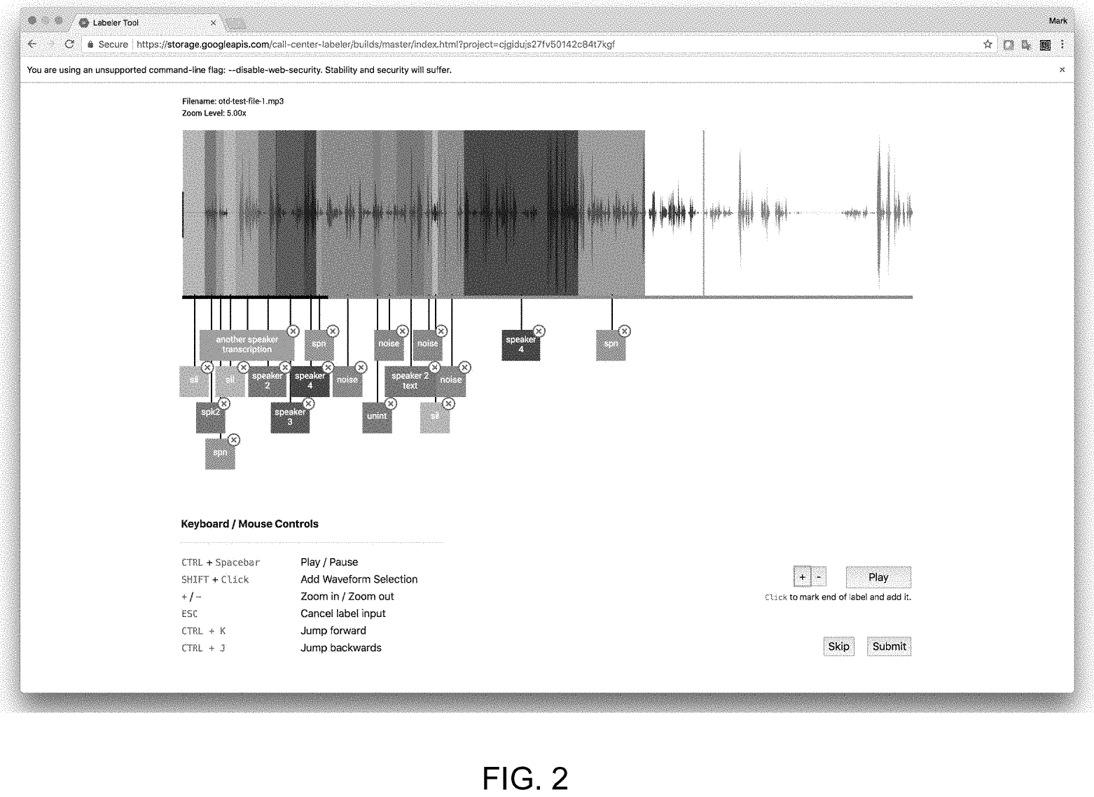

FIG. 3 is a view of the audio labeler Keyboard/Mouse Controls for streamlined user-guided markup of audio files; CTRL+Spacebar (Play/Pause); SHIFT+Click (Add Waveform Selection); +/−(Zoom in/Zoom out); ESC (Cancel label input); CTRL+K (Jump forward); and CTRL+J (Jump backwards).

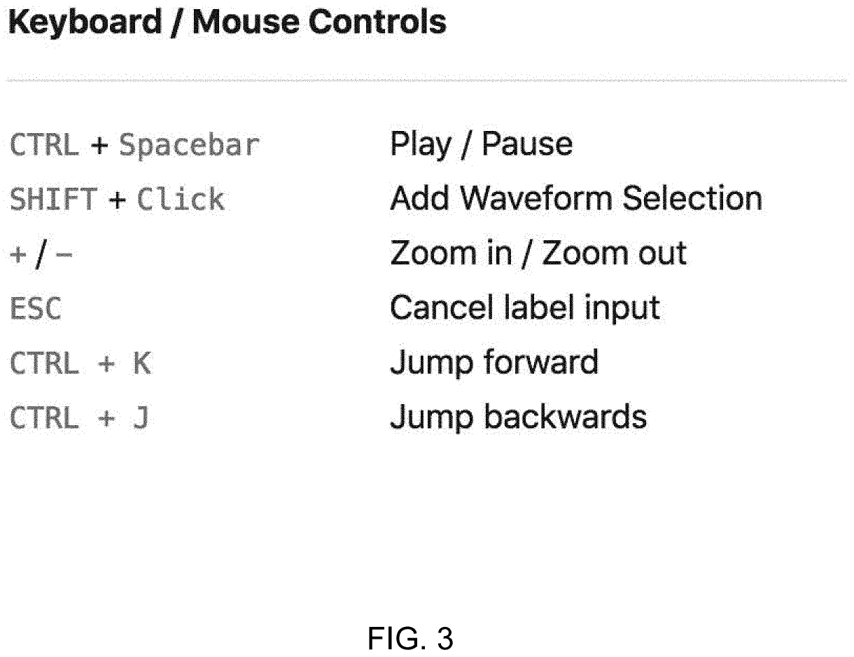

FIG. 4 is a view of the audio labeler configurable menu buttons for zooming in or out (+/−), playing (Play), skipping (Skip), submitting the labeled audio file (Submit), and “Click to mark end of label and add it” functionality.

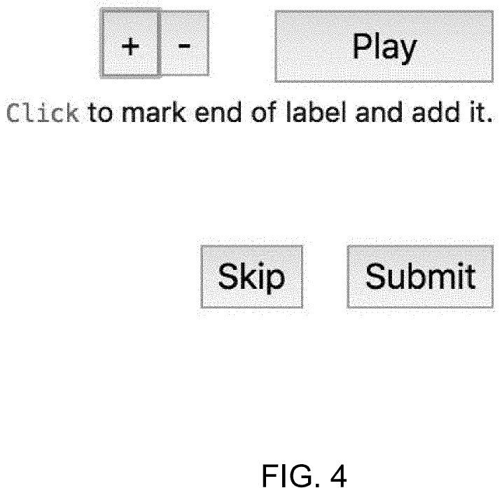

### DETAILED DESCRIPTION

The presently described audio labeler tool was designed to 1) minimize the number of mechanical steps and user interface (UI) mechanics and operations it takes to apply labels, annotations, and literal transcriptions to an electronic audio file; and 2) utilize the labeled audio features and data for training a machine learning system for pre-processing and automatically labeling large audio file datasets at scale. A human labeler will preferably launch the web-browser based audio labeling tool and perform labeling, annotations, and speech to text transcriptions on a set of audio files for describing and characterizing the spoken and unspoken audible content. The audio file may be played and paused by typing CTRL+Spacebar, or another configurable keyboard shortcut, a waveform selection is added by the SHIFT+Click keyboard, and mouse sequence, and the waveform is zoomed in or out with the plus or minus (+/−) keyboard characters. The human labeler may add labels for periods of silence, noise, and speaker identity (i.e., speaker 1, speaker 2, etc.). Speech to text transcriptions may be entered by selecting a region or waveform area and typing SHIFT+Click and then typing the literal transcription of what the speaker is saying, discussing, or asking about. Other variations of keyboard shortcuts, labeling menus, and labeling templates may be provided by the tool for streamlining the audio file labeling and annotation process.

Audio labeling workflow is improved with the labeler tool user interface commands and inputs with regard to adjusting and selecting different waveform areas, regions or features. In a preferred embodiment, the user may move the playhead to a particular selection of the waveform, and the audio player will start with the last two (2) seconds of audio to assist the user with understanding conversational context, mid-sentence, etc., and to avoid having the user hit stop, re-adjust, and hit play redundantly in order to determine the spoken audio meaning. The user may additionally remove and delete labels with a few keystrokes. With the keyboard and mouse controls and by selecting the intended audio file waveform feature visualization, the user may delete a label, add a label for silence, noise, speaker 1, speaker 2, speaker transcription, and emotional sentiment, etc. After a label has been added to the waveform, the tool moves and advances the playhead to to end of the labeled waveform area boundary in order to minimize re-positioning the playhead for the next audio waveform feature selection, annotation, and labeling task. The audio labeler tool provides the user with streamlined user-interface controls and functionality to rapidly advance from audio waveform feature to feature and annotate with labels and speech to text transcriptions.

In a preferred embodiment, the audio labeler tool advances through speaker identities as the labels are applied to the audio waveform. For example, once “speaker 1” is labeled, and the labeler tool playhead is advanced to the next feature selection, the tool will pre-populate the next speaker identity as “speaker 2”; and furthermore, if the user selects the next speaker speech to text transcription, the tool will pre-populate the label with “speaker 3”, etc. In this approach, the preferred embodiment of the audio labeler tool is to perform and execute as many context specific user interface mechanics and labeling tasks as automatically as possible. For example, the labeler tool provides for full customization and configuration of menu options and available context-specific labels. In a preferred embodiment, the user may label specific speakers and waveform features with emotion and sentiment labels. The tool will preferably provide configurable menu options for speech emotion labels, depending on the context and use case. The files may also be pre-processed and the labels may be auto generated using an algorithm. In this case, some or all of the labels will be auto generated and the effort for the human labeler will be that of adding missing labels, correcting mislabeled audio or confirming that some sections of the audio were correctly labelled by the algorithm. This semi-automated workflow rill again reduce the required human effort significantly.

In a preferred audio file use case, the emotion and sentiment labels may preferably reflect speaker or customer satisfaction, frustration, or loyalty, etc.; or alternatively agent or speaker professionalism, compliance, or sales performance. In a preferred embodiment, the audio labeler tool provides fully customizable labeling templates, menus, and pre-populated labeling options for a given customer use case or enterprise application. The labeler templates may enable custom data labeling and labeled dataset building functionality.

In a preferred labeling process workflow, the audio labeler user is presented with a graphical visual waveform, spectrogram, or other representation of the audio file segment. The user may use a mouse, pointing device, or touch screen to select a particular feature or region of the audio file. The audio file feature selection is preferably performed with a two-step process, an initial beginning audio feature selection, and a secondary ending audio feature selection. Selection events performed by the user are visually represented with a circular ring, which flashes on the screen around the center point of the selected feature beginning or end point. A selected audio file feature or region may be highlighted with a colorized overlay, and the time period, or time code, of the length of the selected audio feature is preferably displayed along the graphical visual time scale. Upon selection of a feature, the user is presented with a labeling menu or context-specific template for selection of the proper label, tag, annotation, textual descriptor, emotional characteristic, or speaker identity, etc. The user selects the desired labels, tags, or annotations to be applied to the selected audio file feature or region and the tool inserts the label onto the graphical visual display, with an arrow or leader line connecting the label to the feature. The label or tag may be deleted by the user by selecting the delete-x icon, presented at the corner of the label. For labeling the audio feature immediately following the preceding feature, the user simply selects the ending of the next feature, and the tool graphically highlights with an alternative colorized overlay, with time period, or time code display. The labeling menu is presented once more for the appropriate label, tag, annotation, or speaker identity selection. This process is repeated until all significant audio features, characteristics, or qualities in the audio file segment are annotated and labeled for the given labeling task. The resulting labeled audio file may preferably comprise a graphical visual representation (i.e., waveform, or spectrogram) with multiple labels, tags, and textual annotations with leader lines pointing to colorized or otherwise highlighted sections of audio features or regions. Preferably, on the system side, the features of the audio file with corresponding labels, will be represented as a time slice of the audio file, with a starting and ending time code and an associated label, tag or annotation for that given time slice. The data points or numerical values of a labeled audio feature may preferably comprise an audio file name, a starting time code, an ending time code, and an associated label. Labeled audio file features may also be assigned numeric hashed identifiers.

The audio labeling tool may be used to apply custom, task-specific, use case based, menu labels, or for human validation and quality control of pre-processed, machine generated, or pre-populated labels from pattern recognition, trained neural networks, machine learning or other artificial intelligence leveraged system algorithms. In a preferred embodiment, the human labeler applies labels and speech to text transcription of a control group of audio file segments. The labeled audio file segments and labeled audio features, are extracted, processed, and assigned machine readable signatures, numeric identifiers, hashes, or other machine language based identifiers. Unique segments of human labeled and tagged audio features are used by the system neural network as control groups for pattern recognition, pattern matching, and processing new, additional, unlabeled audio segments, discovering similar audio features, and for applying machine generated labels, speech to text transcriptions, tags, and qualitative descriptors. For example, the human labelers may utilize the audio labeling tool to apply a label to a set of audio file segments or features where the speaker states a common phrase found in the audio file database. Upon building and submitting a control group of human labeled audio file segments for a given commonly uttered phrase by a particular speaker, the system pattern recognition algorithms may thereafter process and pre-populate, additional, unlabeled audio files with the control group label of labels and annotations. The system will thereafter preferably present the users with a large set of pre-processed and machine labeled audio files with a high percentage of accurately, auto generated labels and annotations. Further iterative cycles of human audio segment and audio feature control group labeling and machine generated labeling validation may be completed for adjustment, refinement and improvement of the system machine generated labeling accuracy and pre-processing functionality.

In a preferred embodiment the audio labeler tool may be utilized as a process for quickly and efficiently labeling segments of audio files with keyboard shortcuts. In this scenario, labelers or teams of labelers may be tasked with labeling batches of audio file segments with the audio labeler tool and associated keyboard shortcuts. Labelers may use the mouse and keyboard to select segments of audio files to label. The user interface may present the labeler with a visualization of the audio file segment as a waveform, spectrogram, horizontal graphical representation of values (i.e., frequency, intensity, loudness, tone, pitch, etc.), or other time series graphical visual representation. The interface may be displayed with a web-browser on a desktop computer workstation, mobile computer, tablet, phone, or other mobile computing device. The labeling process may preferably and efficiently comprise the minimal steps of 1) selecting an audio file segment feature; and 2) selecting a single menu item or keyboard shortcut for submitting and applying a labeling tag or label. Labelers may continue selecting portions, segments, or features of the audio file graphical visual representation and continue adding and applying labels with the labeling tool user interface keyboard shortcuts or selectable menu items. Upon completing the labeling or pre-processed labeling validation, the user submits the file to the system for saving and indexing on cloud based storage system. Labelers may preferably manipulate the audio file segment data graphical visual representation by zooming in or out of waveform or spectrogram and additionally by scrolling through the waveform. The audio file, or a selected portion of the file, may be played and listened to with audio labeling tool. The audio file graphical visual visualization may be labeled with color coded sections, or displayed with alternating colors to highlight, and display relevant characteristics and qualities of the file. Labels may be presented as rows of rectangular boxes with textual labeling information, and be arranged along the graphical visual representation of the audio file segment.

In a preferred embodiment, the audio labeling tool user interface may be built and coded with JavaScript, CSS and HTML. An HTML5 canvas may be used to draw or render the graphical, visual, waveform, or spectrogram visualization. A common JavaScript framework such as ReactJS may be preferably utilized for coding the tool and user interface. The audio labeling tool user interface and indexed audio file data and associated labels may be statically hosted on a standard web server computer, HTTP service, or cloud based computing platform. Oauth 2.0 or other mechanism may be preferably employed to authenticate labeler user accounts for access and submitting labeling jobs and batch coding tasks and assignments.

1. A method for building a labeled audio file dataset comprising:
pre-processing an audio file into segments for labeling;
loading an audio file segment into a graphical visual waveform or spectrogram user interface labeling tool;
labeling the audio file by selecting a feature start point, a feature end point, and applying a textual descriptor;
submitting a labeled audio file segment for pattern recognition and machine learning;
auto-generating labels across unlabeled audio file datasets; and
validating machine labeled audio file features for developing accurate labeling algorithms;
wherein human labelers rapidly build a control group of labeled audio data with the labeling tool;
wherein the labeling tool provides streamlined user interface mechanics, keyboard shortcuts, and fast labeling processes; and wherein the manual labeling process may be automated, scaled, and amplified across large unlabeled datasets.

2. The method for building a labeled audio file dataset of claim 1, wherein audio files are pre-processed for identifying periods of silence or noise, for removing parts of the audio file, or for applying preliminary labels, or for segmenting the audio file.

3. The method for building a labeled audio file dataset of claim 1, wherein the audio files and audio file segments may be indexed and loaded from a web address, database, or cloud based storage system.

4. The method for building a labeled audio file dataset of claim 1, wherein the labeling tool may visually display the audio file segment with a waveform, spectrogram, horizontal graphical representation of frequency, intensity, loudness, tone, or pitch, or other time series visual, graphical representation of audible features, characteristics, and qualities.

5. The method for building a labeled audio file dataset of claim 1, wherein the labeling tool user interface mechanics may comprise the steps of 1) selecting an audio segment feature, and 2) selecting a labeling menu item or keyboard shortcut.

6. The method for building a labeled audio file dataset of claim 1, wherein the labeling tool user interface allows manipulation of the audio file segment data graphical visual representation by zooming in or out of the waveform or spectrogram and additionally by scrolling through the waveform.

7. The method for building a labeled audio file dataset of claim 1, wherein the labeled audio file features are assigned numeric hashed identifiers for pattern matching with unlabeled data.

8. A method for labeling audio data at scale comprising:
loading a collection of audio files onto a cloud drive;
indexing the audio files with URL web addresses;
accessing an audio file with a graphical user interface labeling tool;
displaying and selecting audio file waveform features and applying classification and content labels;
submitting labeled audio files for machine learning;
pattern matching labeled audio file features with unlabeled audio file features; and
applying machine generated labels across the entire collection of audio files;
wherein the collection of audio files may be pre-processed into segments by identifying periods of silence; wherein the machine generated labels may be validated by human labelers; and wherein the accuracy of the machine generated labeling process may be improved with a control set of labeled audio data.

9. The method for labeling audio data at scale of claim 8, wherein audio files are pre-processed for identifying periods of silence or noise, for removing parts of the audio file, or for applying preliminary labels, or for segmenting the audio file.

10. The method for labeling audio data at scale of claim 8, wherein the audio files and audio file segments may be loaded from a web address, database, or cloud based storage system.

11. The method for labeling audio data at scale of claim 8, wherein the labeling tool may visually display the audio file segment with a waveform, spectrogram, horizontal graphical representation of frequency, intensity, loudness, tone, or pitch, or other time series visual, graphical representation of audible features, characteristics, and qualities.

12. The method for labeling audio data at scale of claim 8, wherein the labeling tool user interface mechanics may comprise the steps of 1) selecting an audio feature, and 2) selecting a labeling menu item or keyboard shortcut.

13. The method for labeling audio data at scale of claim 8, wherein the labeling tool user interface allows manipulation of the audio file segment data graphical visual representation by zooming in or out of the waveform or spectrogram and additionally by scrolling through the waveform.

14. The method for labeling audio data at scale of claim 8, wherein the labeled audio file features are assigned numeric hashed identifiers for pattern matching with unlabeled data.

15. An audio file labeling process for building labeled datasets at scale comprising:
batching a set of audio file segments for manual labeling and validation by human labelers;
loading an audio file segment into a frontend graphical visual user interface;
playing, listening, pausing, and resuming the audio file;
adjusting the zoom level and viewable area of an audio file segment feature in a waveform, spectrogram, or other audible data visualization;
selecting the beginning time code of an audio file feature;
selecting the ending time code of an audio file feature;
highlighting the selected audio file feature with a visual overlay;
displaying a menu of audio file labels;
tagging the selected audio file feature with a menu label;
processing the labeled audio file features for pattern extraction;
pre-populating labels on unlabeled audio files containing similar feature patterns;
validating machine generated pre-populated labels; and
iterating the process of human labeling, feature extraction, pre-population, and validation in order to improve the accuracy of machine learning algorithmic labeling and building labeled datasets at scale.

16. The audio file labeling process for building labeled datasets at scale of claim 15, wherein audio files are pre-processed for identifying periods of silence or noise, for removing parts of the audio file, or for applying preliminary labels, or for segmenting the audio file.

17. The audio file labeling process for building labeled datasets at scale of claim 15, wherein the labeling tool may visually display the audio file segment with a waveform, spectrogram, horizontal graphical representation of frequency, intensity, loudness, tone, or pitch, or other time series visual, graphical representation of audible features, characteristics, and qualities.

18. The audio file labeling process for building labeled datasets at scale of claim 15, wherein the labeling tool user interface mechanics may comprise the minimal steps of 1) selecting an audio segment feature, and 2) selecting a labeling menu item or keyboard shortcut.

19. The audio file labeling process for building labeled datasets at scale of claim 15, wherein the labeled audio file features are assigned numeric hashed identifiers for pattern matching with unlabeled data.

20. The audio file labeling process for building labeled datasets at scale of claim 15, wherein the menu of audio file labels is configurable for use-case specific applications.
